(19) United States
(12) Patent Application Publication
(10) Pub. No.: US 2018/0124361 A1
(43) Pub. Date: May 3, 2018

(54) IDENTITY ASSOCIATION FOR SECURITY MONITORING

(71) Applicant: Mihai Simon, Aurora, CO (US)

(72) Inventor: Mihai Simon, Aurora, CO (US)

(21) Appl. No.: 15/793,166

(22) Filed: Oct. 25, 2017

Related U.S. Application Data
(60) Provisional application No. 62/416,616, filed on Nov. 2, 2016.

(51) Int. Cl. H04N 7/18; H04N 21/2187; H04N 21/426; G06K 9/00; G06F 9/54

(52) U.S. Cl. CPC H04N 7/18; H04N 21/2187; H04W 84/12; G06K 9/00288; G06F 9/542; H04N 21/42684

(57) ABSTRACT

A system of identity association for security monitoring. An example system includes an event server configured to associate a video feed received from a monitoring location with a mobile device ID for a mobile device at the monitoring location. The example system also includes a database for storing the mobile device ID and corresponding video feed. The database is accessible to associate a later occurrence of the mobile device ID at the monitoring location with the video feed previously associated with the mobile device ID, to assist in identifying a suspect at the monitoring location.

### PRIORITY CLAIM

This application claims the priority benefit of U.S. Provisional Patent Application No. 62/416,616 filed Nov. 2, 2016 titled “Identity Association For Security Monitoring” of Mihai Simon, hereby incorporated by reference for all that it discloses as though fully set forth herein.

### BACKGROUND

Security systems may monitor a breach, such as a door or window opening or being broken. Most security systems today include video camera(s) installed at the property being monitored. These video cameras may be accessed in real-time for monitoring a property remotely (e.g., in a back room or from an off-site location). Video can also be recorded for access at a later time, e.g., during investigation of a break-in. However, depending on the camera angle, it may be difficult if not impossible to identify the perpetrator(s) from the video. Even if a suspect is caught, the video may not be of sufficient quality (e.g., it may not clearly show the suspect) to result in a conviction in criminal court.

### BRIEF DESCRIPTION OF THE DRAWINGS

FIG. 1 shows an example of systems and operations which may be implemented for identity association for security monitoring,

### DETAILED DESCRIPTION

Identity association for security monitoring is disclosed. Identity association for security monitoring system and method disclosed herein may be configured to identify or assist in identifying involvement in an event, thereby reducing investigation time and resources following an event such as an intrusion or arson fire. The system and method may also include notification configured to notify a remote administrator with information and video (e.g., identifying a person in the building and/or accessing the device).

In an example, identity association for security monitoring may be implemented as part of or with a security system. The security system may include building security devices such as a burglar alarm. The security system may be configured with various other hardware components, including a universal power supply (UPS) and battery backup for continuous access and monitoring. The hardware components may be located in one or more enclosure. The security system may also include communications via a local control panel and/or remote means (e.g., a networked computer or mobile device).

The security system may include a closed circuit television (CCTV) and/or other video monitoring equipment. The video component may display events in real-time and/or record events on a local and/or remote storage device. Example identity association for security monitoring utilizes as input a live video feed and/or video recording to assist in identification of a suspect.

Before continuing, it is noted that as used herein, the terms “includes” and “including” mean, but is not limited to, “includes” or “including” and “includes at least” or “including at least.” The term “based on” means “based on” and “based at least in part on.”

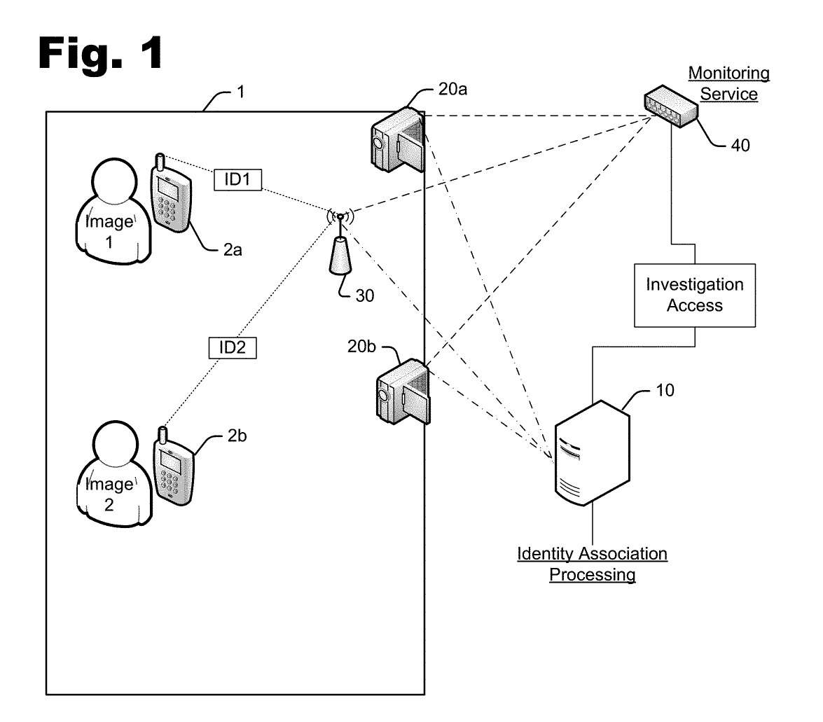

FIG. 1 shows an example of systems and operations which may be implemented for identity association for security monitoring. In an example, a system of identity association for security monitoring includes an event server 10. The event server 10 may be configured to associate a video feed received from one or more video devices 20a-b at a monitoring location 1 with a mobile device ID for a mobile device 2a, 2b at the monitoring location 1. The mobile device ID may be received from one or more wireless access point 30 at the monitoring location 1.

The video feed may show an image of a person associated with (e.g., holding) the mobile device 2a, 2b. The video feed, taken during a prior visit of the person to the monitoring location, such as during normal business hours at a store, is likely to be more clear than during an event such as a break-in. That is, a person coming into the place of business during normal business hours likely would not try to hide their identity, e.g., while “casing” the business for a later break-in. The person will likely try to appear as a regular customer so as not to raise suspicion. The event server 10 may associate and store the mobile device ID and corresponding video feed, e.g., in a database.

If that person returns at a later time, e.g., to commit a crime, a security monitoring service 40 may receive video of the crime. However, the video may not clearly show the perpetrator, e.g., if the perpetrator is wearing a mask or hoodie. The security monitoring service 40 may also receive a mobile device ID associated with the perpetrator.

The database is later accessible, e.g., during an investigation into a burglary or arson fire or other crime. A later occurrence of the mobile device ID at the monitoring location (e.g., during the burglar or arson fire) can be associated with the same mobile device ID associated with a video feed previously associated with the mobile device ID, to assist in identifying a suspect at the monitoring location.

Before continuing, it should be noted that the examples described above are provided for purposes of illustration, and are not intended to be limiting. Other devices and/or device configurations may be utilized to carry out the operations described herein.

The operations shown and described herein are provided to illustrate example implementations. It is noted that the operations are not limited to the ordering shown. Still other operations may also be implemented.

Example operations of identity association for security monitoring method include receiving a video feed received from a monitoring location; receiving a mobile device ID for a mobile device at the monitoring location; associating the video feed with the mobile device ID when there is correspondence in time; storing the mobile device ID and corresponding video feed; and providing access to the stored video feed based on a later occurrence of the mobile device ID to assist in later identifying a suspect.

It is noted that the examples shown and described are provided for purposes of illustration and are not intended to be limiting. Still other examples are also contemplated.

1. A system of identity association for security monitoring, comprising:
an event server configured to associate a video feed received from a monitoring location with a mobile device ID for a mobile device at the monitoring location; and
a database for storing the mobile device ID and corresponding video feed, wherein the database is accessible to associate a later occurrence of the mobile device ID at the monitoring location with the video feed previously associated with the mobile device ID, to assist in identifying a suspect at the monitoring location.

2. The system of claim 1, further comprising a wireless access point providing the mobile device ID.

3. The system of claim 1, wherein the mobile device ID is a unique identification of the mobile device.

4. The system of claim 1, wherein the mobile device ID is a MAC address.

5. The system of claim 1, wherein the video feed includes at least one still image.

6. A method implementing the system of any of claims 1-6, comprising:
receiving a video feed received from a monitoring location;
receiving a mobile device ID for a mobile device at the monitoring location;
associating the video feed with the mobile device ID when there is correspondence in time;
storing the mobile device ID and corresponding video feed; and
providing access to the stored video feed based on a later occurrence of the mobile device ID to assist in later identifying a suspect.

7. The method of claim 6, further comprising receiving the mobile device ID via a wireless access point.

8. The method of claim 6, wherein the mobile device ID is a unique identification of the mobile device.

9. The method of claim 6, wherein the mobile device ID is a MAC address.

10. The method of claim 6, further comprising filtering the video feed for at least one still image.

11. A system of identity association for security monitoring, comprising:
a security subsystem configured to identify or assist in identifying involvement in an event, thereby reducing investigation time and resources following an event such as an intrusion or arson fire; and
a notification subsystem configured to notify a remote administrator with information and video identifying a person in the building and/or accessing the device.

12. The system of claim 11, wherein the security further comprises building security devices, and is configured with various subsystem other hardware components, including a universal power supply (UPS) and battery backup for continuous access and monitoring.

13. The system of claim 12, wherein the hardware components are located in one or more enclosure.

14. The system of claim 11, wherein the security system includes communications via a local control panel and/or remote means.

15. The system of claim 11, television (CCTV) and/or other video monitoring equipment.

16. The system of claim 11, wherein the video subsystem is configured to display events in real-time and/or record events on a local and/or remote storage device.

17. The system of claim 11, wherein the video subsystem utilizes as input a live video feed and/or video recording to assist in identification of a suspect.
